(19) United States
(12) Patent Application Publication
(10) Pub. No.: US 2009/0298460 A1
(43) Pub. Date: Dec. 3, 2009

(54) Emergency Notification Paging System

(75) Inventors: Perry H. Ruda, West Palm Beach, FL (US); Arthur Eisenberg, West Palm Beach, FL (US); Ernest B. Reeve, Tallahassee, FL (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Always On Alert, LLC, Tallahassee, FL (US)

(21) Appl. No.: 12/476,840

(22) Filed: Jun. 2, 2009

Related U.S. Application Data
(60) Provisional application No. 61/058,302, filed on Jun. 3, 2008.

(51) Int. Cl. H04M 11/04

(52) U.S. Cl. 455/404.1

(57) ABSTRACT

A communication network uses a broadcast network and a plurality of receivers with a common device identifier. When a message is sent over the broadcast network it is received simultaneously by each receiver, allowing fast, uniform information transmission. An embodiment of a receiver has an audible alert as well as a text display. One embodiment of the receiver has no power switch so the device cannot be turned off but has a battery life of one year or more. When deployed in a geographically dispersed area, such as a college campus, airport, or seaport, messages sent via the communication network allows an authorized party to issue almost instantaneous updates on critical events, such as a terrorist strike or natural disaster. To encourage use, the receivers may be suitable for use as a key fob and may be color coded, for example, using a university's own color scheme.

This application claims priority to U.S. Provisional Application 61/058,302, filed Jun. 3, 2008, and is incorporated by reference for all purposes.

### BACKGROUND

A paging network or cellular text messaging may be used to relay simple alerts or text messages. Some network operators allow a group to be set up that includes a number of subscriber devices to be contacted via a single activation by a sender. However, these groups are maintained at the switch and require deconstruction at the switch or head-end into individually addressed, serial messages. Attempts to scale this technique to hundreds or more users in a conventional system may result in overwhelming the network equipment, imposing long delays between the first and last message delivery, or both.

Cellular-based network messaging, such as SMS or even voice call connection may become slow or unresponsive in an emergency situation traffic can overwhelm both the base station receivers and their associated switches as a result of the spike in volume.

### SUMMARY

A communication network, such as a paging network, may use customized subscriber devices that each have a shared device identifier (e.g., a CAP code). An authorized user may activate the network to send a message to each subscriber device virtually simultaneously because each subscriber device will process a single incoming message as being directed specifically to itself.

Because the subscriber device is intended for infrequent, as opposed to daily use (business applications, for example) a subscriber device's receiver may use a messaging protocol structured for very long battery life. To simplify operation, a user interface on the subscriber device may be limited to a text display and an audible alarm, with no buttons or entry devices, including no power switch to help ensure the device is always on and ready to receive messages. A small configuration may encourage use as a key fob or other easily carried accessory.

One application for the communication network may include use as a campus-wide alert system for use during an extreme emergency, such as the tragic events at Virginia Tech and Northern Illinois University. Other applications may include high rise buildings, seaports, airports, military bases, etc., where fast distribution of emergency messages may be critical for the public safety. Because a user's wireless device is compact and maintenance-free over a long period, it may be freely distributed not only to students, but also to employees that would not normally have two-way radios, such as professors on a college campus or cleaning crews at an airport.

To assist in identifying the subscriber device, individual units may use school-specific colors or logos.

### BRIEF DESCRIPTION OF THE DRAWINGS

FIG. 1 is an illustration of an exemplary embodiment of a wireless device for use in a mass notification system;

FIG. 2A is a block diagram of an emergency alert system;

FIG. 2B is a block diagram of another emergency alert system suitable for wider-area coverage than the system of FIG. 1;

FIG. 3 is a block diagram of an exemplary emergency alert system subscriber device;

FIG. 4 is a block diagram of an exemplary emergency alert system input terminal; and

FIG. 5 is a method of authorizing and sending an emergency alert signal.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

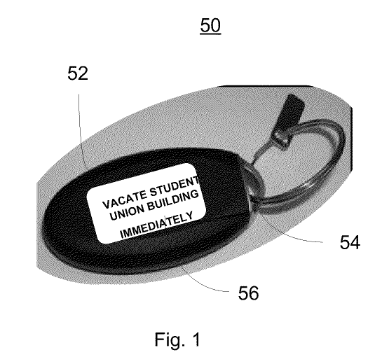

FIG. 1 illustrates a representative embodiment of a mass messaging wireless device 50 in the form of a key fob. The wireless device 50 may have a housing 52, a keyring loop 54, and a display 56. Optional keys (not depicted) may be used for controlling the wireless device 50, as described in more detail below.

Because the key fob-sized device is a convenient size that allows for easy placement in a pocket or purse, the mass messaging wireless device may be carried on one's person at all times. In one embodiment, the keyfob may be permanently attached to a university-issued room key or access card (not depicted), so that a student will necessarily have the device with him or her at all times.

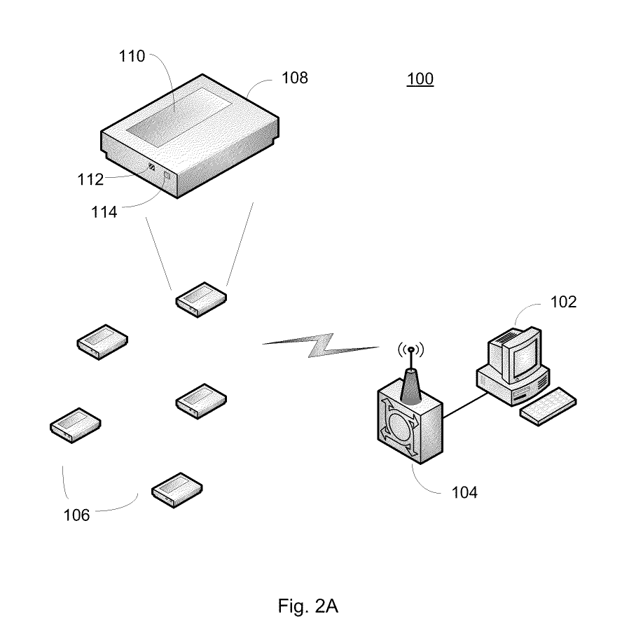

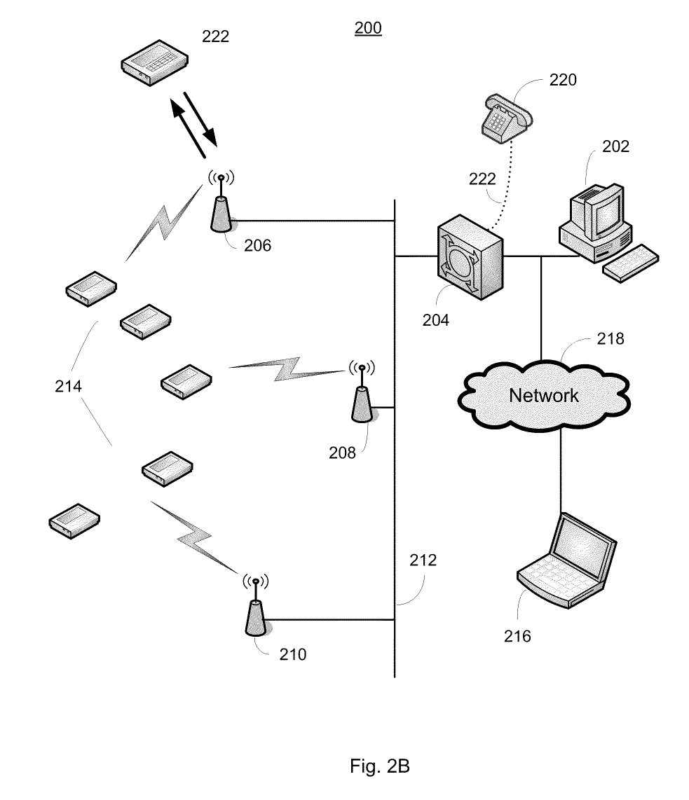

With reference to FIG. 2A, an exemplary communication system 100 supporting an emergency alert notification is discussed and described. A computer 102, or other message input device may be coupled to a messaging terminal 104. One embodiment of the messaging terminal 104 may include a transmitter capable of a sending a wireless signal to one or more wireless devices 106. Each wireless device, shown in close-up as device 108, may include a display 110, an audible alert 112, and an operation indicator 114. The display 110 may be a two line display, or larger, as power considerations allow. In some embodiments, the wireless device 108 may not have an input capability, that is, no provision may be available to scroll messages, disable alerts, or turn off the device. In other embodiments, a limited input capability may allow service checking, message scrolling or deletion, battery lifetime checking, etc.

In an alternate embodiment, the wireless device 108 may be implemented in custom or semi-custom circuitry, allowing a small, thin profile suitable for attachment to a cellular telephone or iPod™, even though the two devices may operate independently. In another embodiment, the wireless device 108 may transmit a low-power output signal on an FM radio channel to a user's cellular telephone or personal music device (e.g. iPod™).

In yet another embodiment, the wireless device 108 may be constructed without an on/off switch so that a device may not be inadvertently switched off. Similarly, a battery compartment (not depicted) may be sealed so that the battery is not removable or, in some cases, is not rechargeable by users.

The computer 102 may be a standard personal computer with software for coupling to the messaging terminal 104. The interface may be proprietary or may be offered as a web service by the messaging terminal 104. To encourage carrying the wireless device 108, it may follow a campus-specific color scheme or come in a variety of colors.

In operation, when a decision maker determines to send an emergency alert message, he or she may present credentials via the computer 102 to access a messaging application. The credentials may be a simple username/password, or may include a token such as a smartcard or even biometrics. In most cases, particularly in a campus environment, activation of the communication network 100 may be in response to a serious circumstance and only those with sufficient authority and access to accurate information may be allowed access to the communication system 100.

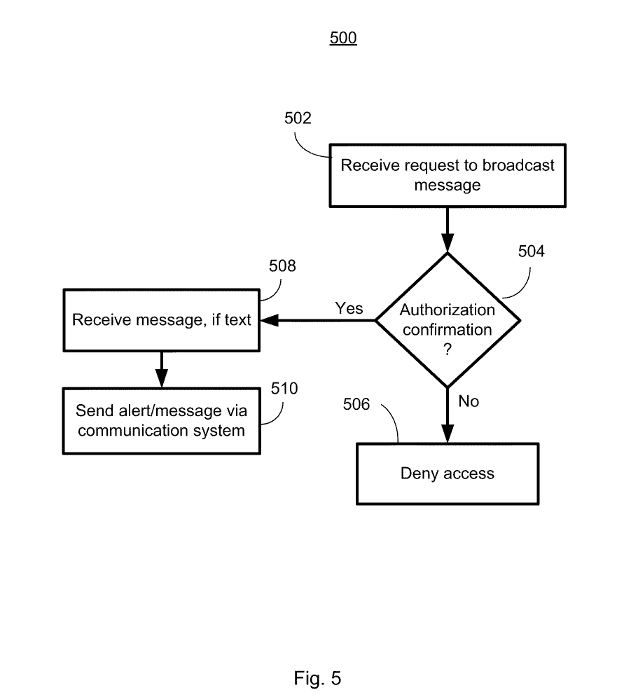

The messaging terminal 104 may be a standard paging terminal/transmitter, supporting, for example, industry standard POCSAG/FLEX™/ReFLEX™ protocols. The system depicted in FIG. 2A may be suitable for a small geographic area, with the communications controller 104 implemented in a single-self contained unit. One embodiment, described in more detail below with respect to FIG. 5, may allow direct entry of credentials and message content, bypassing the computer 102. Remote access may also be supported in the configuration of FIG. 2A, and is described in more detail below, with respect to FIG. 2B.

FIG. 2B illustrates a more sophisticated version of the communication system 100 of FIG. 1. The communication system 200 includes a computer/console 202, a communications controller 204, and a plurality of station transmitters 206, 208, 210 coupled to the messaging terminal 204, via a network 212. As above, a plurality of wireless devices 214 may be deployed in the communication system 200. Each wireless device 214 may have a common device identifier.

Remote access may be supported via a second computer 216, such as a laptop computer, cellular telephone, etc., over a network 218, such as the Internet. Depending on configuration, the remote access may supported directly with the communications controller 204 or through the computer 202. In either case, credentials may be more closely scrutinized to prevent hacking.

Another method for accessing the messaging terminal 204 may be via dial up from a standard telephone 220 via a plain old telephone (POTS), or similar telephone network 222. Presentation of a login sequence of digits may then allow an authorized party to either input a numeric message to be sent, or to select from a menu of predefined text messages. Such predefined text messages may include a variety of safety advice messages such as, “stay in your dorm or classroom,” or “all-clear.”

In the configuration of FIG. 2, the station transmitters 206, 208, 210, may be configured to operate in a “simulcast” mode, known in the industry, to provide greater geographic coverage or more complete coverage for difficult terrain. In dense areas, a common broadcast system may be shared by more than one entity, e.g. neighboring college campuses or government agencies. Each messaging terminal may be able to send only to its affiliated devices by their common device identifiers.

The systems of both FIG. 2A and FIG. 2B may be deployed in a number of different configurations. For example, the simplest configuration may have each wireless device 106, 214 use a single, common device identifier. Other embodiments may allow groups of devices deployed with non-overlapping device identifiers, e.g. students, faculty, first responders, administrators, females, etc. In yet other embodiments, overlapping device identifiers may be deployed allowing everyone to get some messages, and different subgroups to receive more targeted messages.

FIG. 2B also illustrates a second type of wireless device 222 that may be deployed, having a keyboard and the optional ability to communicate directly to the messaging terminal 204 via the station transmitters 206, 208, 210, or, in this embodiment, station transceivers. In some cases, for example, a natural disaster, network or telephone access to the messaging terminal 204 may blocked. However, when self contained, that is, with its own power source, the messaging terminal 204 may function to deliver messages without reliance on any third party equipment, such as a local telephone provider.

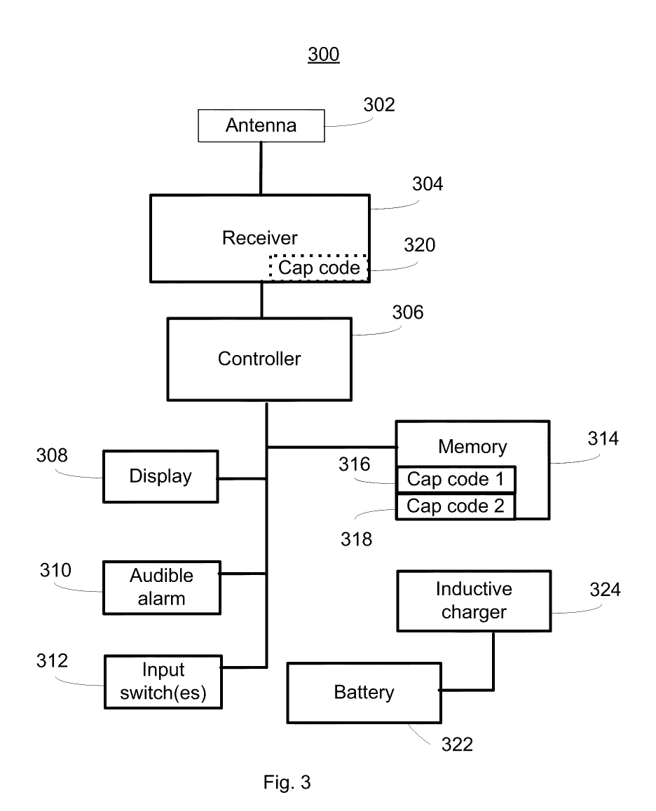

FIG. 3 illustrates an exemplary wireless device 300, similar to wireless device 108 of FIG. 1. The wireless device 300 may include an antenna 302 coupled to a receiver 304. A controller 306, such as a small ARM™ embedded controller, may be programmed to manage the user interface and receiver back-end functions. A display 308 may be used to display text or graphical messages. In one embodiment, a two line liquid crystal display may be used, in other embodiments, larger displays may be used. An audible alarm 310 may be used to draw attention to receipt of a message. An input switch 312, or optionally, switches may allow a user to scroll through messages, select messages, or delete messages. An optional backlight (not depicted) may allow use in low-light conditions.

A memory 314 may be used should the controller 306 need additional volatile or non-volatile memory. The memory 314 may include program memory, message storage, or both. In one embodiment, a first device identifier 316 may be used as by the controller 306 to select signals intended for itself. In one embodiment, a single device identifier 316 may be used for each wireless device 300 in a system, so that a single broadcast message will be interpreted by each wireless device 300 as intended for itself, and accepted.

In another embodiment, an additional, unique, device identifier 318 may be included so that the wireless device 300 may be sent an individually-targeted message.

The battery 322 may be non-removably mounted in the wireless device 300. In one embodiment, an inductive charger 324 may be incorporated to allow charging, if necessary. In an exemplary deployment on a college campus, the battery and paging system collapse code may be selected to last 9-10 months on a single charge, allowing uninterrupted use for a school year. The collapse code is a system setting that determines how often the wireless device 300 will “wake up” and check for messages. Since even the longest delay is typically a matter of seconds, there would not be a significant delay in getting an emergency message to the wireless device 300.

In one embodiment, the receiver 304 may be hard coded with a device identifier 320 (or CAP code). In this embodiment, the receiver 304 may be programmed at an early manufacturing cycle, e.g. with fusible links, so that the receiver 304 detects the over-the-air signal address before the controller 306 is involved in message processing. Because the wireless device 300 has a long operation life on a single battery, up to a year, screening messages at the receiver 304 may be more power efficient than using the controller 306 to screen incoming messages.

In another embodiment, the additional CAP code 318, or more, as needed, may be used for messages sent in another language, when a target population is sufficiently diverse that more than one language would be helpful in spreading an emergency alert.

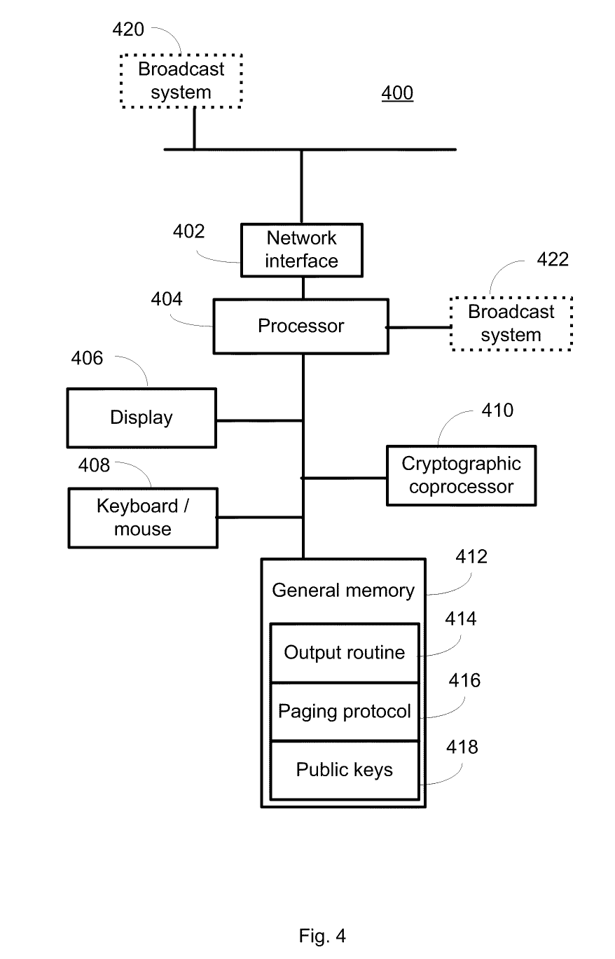

FIG. 4 is a block diagram of an exemplary messaging terminal 400. The messaging terminal 400 may include a network interface 402, that may support a both wide area and telephone modem connections. A processor 404 may be used to manage inbound and outbound messaging functions as well as support operating system and user interface functions. A display 406 and keyboard/mouse 408 may allow an authorized user to activate messaging functions. A cryptographic coprocessor 410 may store cryptographic keys and perform the cryptographic functions used to provide an authorization service for evaluating user credentials to allow access to messaging functions. The cryptographic coprocessor may also incorporate a biometric sensor for use in confirming the identity of a user accessing the alerting functions. In one embodiment, the cryptographic coprocessor 410 may store biometric corroboration, such as fingerprint minutiae, for post-event analysis. In one embodiment, a smart card or smart chip may be used to perform these functions. In another embodiment, a dedicated plug in card, such as an IBM 4758 coprocessor card can perform these functions, although other security mechanisms are also possible.

A general memory 412 may include both volatile and non-volatile memory structures. The general memory 412 may store operational programs, such as an output routine 414, paging protocol code 416, and public keys 418 that do not require protection from discovery.

The network interface 402 may support both incoming traffic from a user and outbound traffic to a broadcast system 420. In another embodiment, to further secure the system, a private connection may be used to connection to a broadcast system 422.

In operation, the messaging terminal 400 may allow direct access for authenticating a user and sending a message to one or more individual wireless devices, e.g. wireless device 300, or all wireless devices in a communication network, e.g. communication network 200. Alternatively, a user may access the messaging terminal 400 via a telephone set (not depicted) or a local-area or wide-area network, such as a campus Intranet or the Internet, respectively.

FIG. 5 illustrates a method 500 of sending messages to a plurality of wireless devices, such as wireless devices 214 of FIG. 2. At block 502, a messaging terminal 204 may receive a request to broadcast a message. At block 504, the messaging terminal may determine whether the user's credentials are authentic. User authentication may be performed by any number of common methods, including identifier/password, login token, smartcard, or biometric.

If the credentials are not accepted, the “no” branch from block 504 may be taken to block 506 and access may be denied. In some cases, no error message may be returned upon a login failure to deter hacker attempts. In some embodiments, the login process may use known techniques to limit denial of service (DOS) attacks.

If, at block 504, the credentials are accepted, execution may follow the “yes” branch to block 508. If, at block 508 a text message is to be relayed, the body of the message may be received.

At block 510, the message may be sent via a broadcast system, for example, simulcast paging transmitters 206, 208, 210.

A standard paging network allows virtually any user to connect to the paging network and send a message to a single, identified user, or in some cases a limited group of users over a period of time.

In contrast to a standard paging network, the method and equipment described above allow a limited, select group of personnel to send a message to a large community of users at virtually the same instant. The described system allows members of a community to have on their person, in the form of a key fob or pendent, a wireless device that can provide them with almost instant, consistent, and informed news and instructions when a crisis situation occurs. Similarly, security personnel and administrators for that community are provided a tool for quickly disseminating information to the members of the community to prevent rumor and panic from exacerbating a developing situation. Even non-members of the community, such as parents and other loved-ones, can gain assurance from the knowledge that such an alert system is in place to disseminate accurate information in a crisis.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A mass notification system comprising:
an input terminal;
an authorization service coupled to the input terminal to confirm an authorization to access the mass notification system;
a broadcast network coupled to the input terminal; and
a plurality of wireless devices, each of the plurality of devices simultaneously responsive to a message from the broadcast network, each of the plurality of devices comprising:
a receiver responsive to a shared device identifier;
an audible transducer coupled to the receiver;
a text display coupled to the receiver;
an operation indicator; and
a power source supplying power to the device.

2. The mass notification system of claim 1, wherein the authorization service processes stores and processes biometric data for user verification.

3. The mass notification system of claim 1, wherein each of the plurality of wireless devices is a keyfob.

4. The mass notification system of claim 1, wherein the keyfob is permanently attached to a door entry key or keycard.

5. The mass notification system of claim 1, wherein each of the plurality of wireless devices comprises a common, fixed, device identifier.

6. The mass notification system of claim 5, wherein the device identifier is a paging system CAP code.

7. The mass notification system of claim 6, wherein each of the plurality of wireless devices includes only two CAP codes, with each of the two CAP codes duplicated in each of the plurality of wireless devices.

8. The mass notification of system of claim 7, wherein the first of the two CAP codes is associated with messages broadcast in a first language and the other of the two CAP codes is associated with messages broadcast in a second language.

9. The mass notification system of claim 1, wherein each of the plurality of wireless devices is fixed in an operational state and is free of a user-operable interface for deactivating itself.

10. The mass notification system of claim 1, wherein the power source is one of a battery and a super capacitor.

11. The mass notification system of claim 1, wherein each of the plurality of wireless devices has a mute switch.

12. The mass notification system of claim 1, wherein the plurality of wireless devices comprises a set of at least 1000 wireless devices.

13. A method of operating a mass notification system comprising:
providing to substantially all members of a population a separate wireless notification device, all of the wireless notification devices having a common device identifier;
accepting an authentication credential from a user;
determining the user is authorized to send a message via the mass notification system by evaluation of the authentication credential;
sending a message from the user to each wireless notification device having the common device identifier; and
emitting an audible alarm from each of the wireless notification devices and displaying a common visible message at each of the wireless notification devices responsive to receiving the message.

14. The method of claim 13, wherein the common device identifier is a CAP code common to each of the wireless notification devices.

15. The method of claim 13, further comprising sending a second message in a language different from the message to each wireless notification device having the common device identifier.

16. The method of claim 13, wherein providing the separate wireless notification device comprises providing the separate notification device with a second device identifier, the second device identifier also common to each wireless notification device.

17. The method of claim 15, further comprising sending a second message in a language different from the message to each wireless notification device using the second device identifier.

18. The method of claim 13, wherein accepting the authentication credential from the user comprises collecting a biometric measurement from the user.

19. A wireless notification device for use in a mass notification system, the wireless notification device comprising:
a receiver responsive to a shared device identifier;
an audible transducer coupled to the receiver;
a text display coupled to the receiver;
an operation indicator;
a power source permanently supplying power to the wireless notification device until the power source is exhausted; and
a processor for comparing an incoming message to the shared device identifier and activating the audible transducer in every case when the incoming message matches the shared device identifier.

20. The wireless notification device of claim 19, further comprising a mute switch for silencing the audible transducer after the audible transducer is activated responsive to the incoming message having the shared device identifier.
